(19) United States
(12) Patent Application Publication
(10) Pub. No.: US 2008/0091752 A1
(43) Pub. Date: Apr. 17, 2008

(54) COMPUTER BASED CALCULATOR WITH SAVABLE AND PRINTABLE OUTPUT

(76) Inventor: Peter C. Powles, New York, NY (US)

Correspondence Address: WALTER J. TENCZA JR., 100 Menlo Park, Suite 210, Edison, NJ, 08837, US

(21) Appl. No.: 11/309,845

(22) Filed: Oct. 11, 2006

(51) Int. Cl. G06F 3/147

(52) U.S. Cl. 708/160

(57) ABSTRACT

A computer processor is disclosed, which is programmed to display on a screen of a computer monitor a calculator image having a first field. The first field can be activated using the interactive device to cause calculations performed using the calculator image to be displayed on the screen of the computer monitor on a spreadsheet image. The calculator image may have a second field which can be activated using the interactive device to stop calculations performed using the calculator image from being displayed on the spreadsheet image. The second field when activated may allow a user to save calculations performed using the calculator image to a computer memory.

### FIELD OF THE INVENTION

This invention relates to improved methods and apparatus concerning computer calculators.

### BACKGROUND OF THE INVENTION

There are various devices known in the prior art for implementing calculators on computers.

### SUMMARY OF THE INVENTION

In one embodiment, the present invention provides a computer based calculator, from which a user can track his/her work in a savable and printable format.

An apparatus may be provided comprising a computer processor, an interactive device,

a computer memory, and a computer monitor having a screen. The computer processor may be programmed to display on the screen of the computer monitor a calculator image having a first field. The first field can be activated using the interactive device to cause calculations performed using the calculator image to be displayed on the screen of the computer monitor on a spreadsheet image.

The calculator image may have a second field, which can be activated using the interactive device to stop calculations performed using the calculator image from being displayed on the spreadsheet image. The second field when activated may allow a user to save calculations performed using the calculator image to the computer memory. The computer processor may cause the calculator image and the spreadsheet image to be displayed on the screen of the computer monitor at the same time when the first field is activated.

The spreadsheet image is produced by a spreadsheet computer program, such as an Excel (trademarked) computer program. The calculator image may be produced by a Windows (trademarked) computer program.

One embodiment of the present invention also provides a method comprising displaying on a screen of a computer monitor a calculator image having a first field which can be activated using an interactive device to cause calculations performed using the calculator image to be displayed on the screen of the computer monitor on a spreadsheet image.

### BRIEF DESCRIPTION OF THE DRAWINGS

FIG. 1 shows an apparatus, including a monitor, processor, memory, and an interactive device, which can be used in accordance with an embodiment of the present invention;

FIG. 2 shows a first image or calculator image, which can be displayed on a screen of the computer monitor of the apparatus of FIG. 1, in accordance with an embodiment of the present invention;

FIG. 3 shows a second image or spreadsheet image, which can be displayed on a screen of the computer monitor of the apparatus of FIG. 1, in accordance with an embodiment of the present invention;

FIG. 4 shows a third image, having both the calculator image and the spreadsheet image, which can be displayed on a screen of the computer monitor of the apparatus of FIG. 1, in accordance with an embodiment of the present invention; and

FIG. 5A and FIG. 5B show fourth and fifth images for display on the computer monitor of the apparatus of FIG. 1 in accordance with another embodiment of the present invention.

### DETAILED DESCRIPTION OF THE DRAWINGS

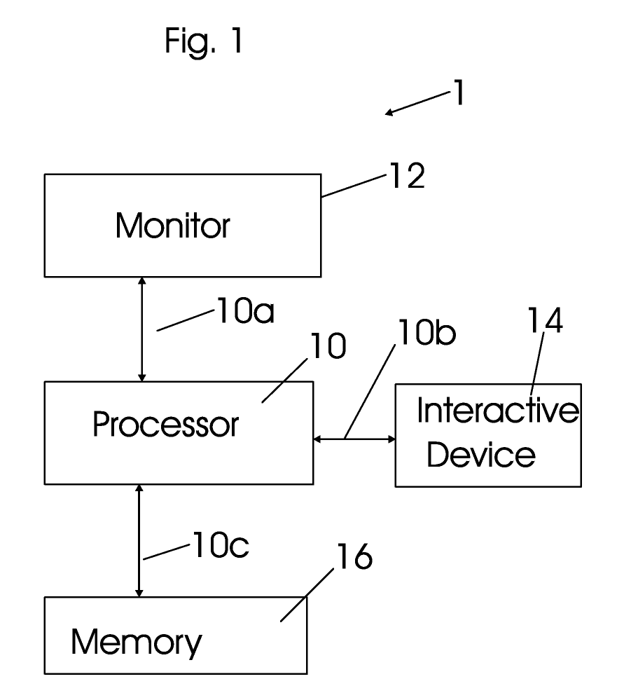

FIG. 1 shows a flow chart of an apparatus 1 in accordance with an embodiment of the present invention. The apparatus 1 includes a processor 1 0, a monitor or display 1 2, an interactive device 14, and a memory 16. The monitor 12, interactive device 14, and the memory 16 are connected by communications lines 10a, 10b, and 10c, respectively, to the processor 10.

The processor 10 may be a personal computer. The memory 16 may be computer memory, which may be part of the personal computer. The monitor or display 12 may be a computer monitor for the personal computer. The interactive device 14 may include a keyboard, computer mouse, a computer screen, or any other interactive device for inputting data into a computer.

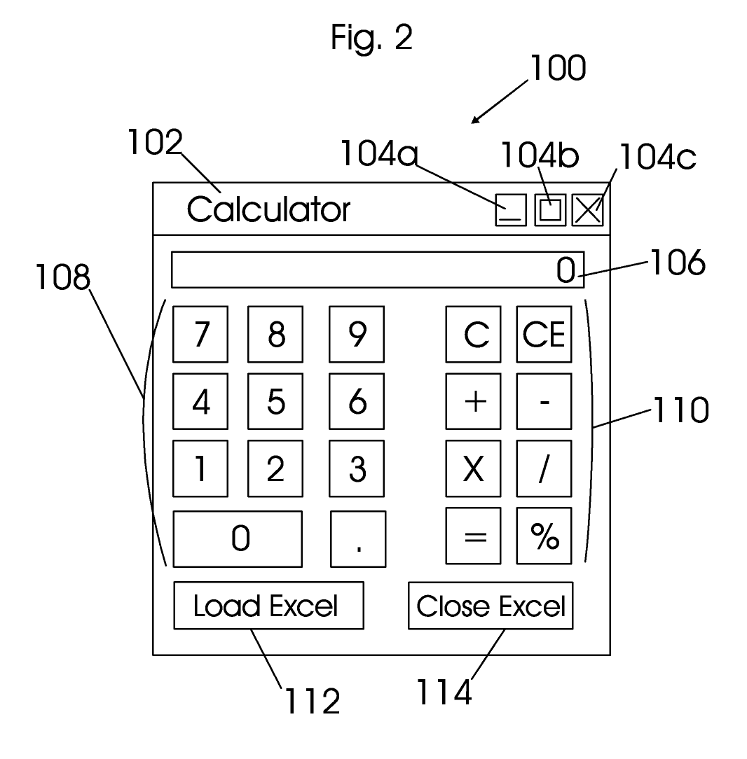

FIG. 2 shows a first image 1 00 which can be displayed on a screen of the monitor 12 of the apparatus 1 of FIG. 1, in accordance with an embodiment of the present invention. The image 100 includes text 102 specifying that this screen or image relates to a “Calculator”. The image 100 also includes fields 104a, 104b, and 104c which are typically Windows (trademarked) fields allowing a user to minimize, maximize and close, respectively, the image 100, on the screen of the monitor 12.

The image 100 includes a field 106 in which a number (such as the number 0 which is shown) may be displayed. The number displayed in the field 106 may be displayed as negative with a “−” sign or positive with a positive “+” sign. The number displayed in field 106 may be a decimal number. The image 100 also includes a keypad or plurality of keys or buttons 108. The buttons 108 includes buttons for digits “0” through “9” and a button for a decimal point. The image 100 also includes a keypad or plurality of keys or buttons 110. The buttons 110 include buttons identified as “C”, “CE”, “+”, “−”, “×”, “/”, “=”, and “%”, which are for clearing the field 106 (i.e. resetting the field 106 so it displays “0”), clearing the field 106, adding, subtracting, multiplying, dividing, equals, and changing to a percent, respectively. A typical Windows (trademarked) calculator may include 102, 104a-c, 106, 108, and 110 as known in the art.

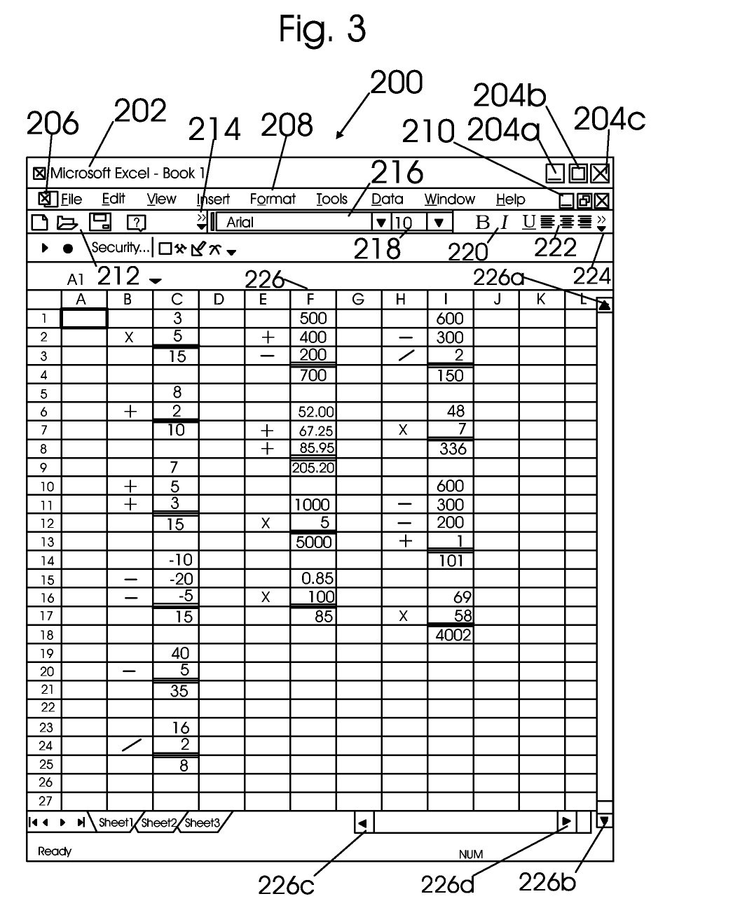

The image 100 also includes field or button 112, which is for loading an Excel (trademarked) computer program using processor 10, so that an Excel (trademarked) spreadsheet, such as shown in FIG. 3, appears on the screen of the monitor 12. The image 100 also includes a field or button 114, which is for closing an Excel (trademarked) spreadsheet computer program, so that the Excel spreadsheet does not appear on the screen of monitor 12.

FIG. 3 shows a second image 200 which can be displayed on a screen of the monitor 12 of the apparatus 1 of FIG. 1, in accordance with an embodiment of the present invention. The image 200 includes text 202 specifying that this screen or image relates to a “Microsoft Excel—Book 1” (Microsoft (trademarked), Excel (trademarked)). The image 200 also includes fields 204a, 204b, and 204c which are typically Windows (trademarked) fields allowing a user to minimize, maximize and close, respectively, the image 200, on the screen of the monitor 12.

The image 200 also includes an icon 206 which can be clicked by a computer cursor of the interactive device to create a new Excel (trademarked) workbook. The image 200 also includes fields or buttons 208, which include “File”, “Edit”, “View”, “Insert”, “Format”, “Tools”, “Data”, “Window”, and “Help” fields. The functions of the fields or buttons 208 are known and relate to the known operation of the Microsoft (trademarked) Excel (trademarked) computer program. The image 200 also includes fields 210 which are typically Microsoft (trademarked) Excel (trademarked) fields allowing a user to minimize, maximize and close, respectively, a grid or spreadsheet 226, on the screen of the monitor 12.

The image 200 also includes fields, button, or icons 212, which is related to opening a file in Windows (trademarked). The image 200 also includes field 214, which lists additional Excel (trademarked) features, currently hidden. Field 216 specifies the font of text to be applied to the grid 226. A down scroll arrow adjacent and to the right of field 216 allows a user to scroll through different fonts to enter into field 216. Field 218 specifies the size of text to be applied to the grid 226. A down scroll arrow adjacent and to the right of field 218 allows a user to scroll through different text sizes to enter into field 216. The image 200 includes fields, buttons, or icons 220 which relate to bolding, italicizing, and underlining text to appear in grid 226. The image 200 also includes fields, buttons, or icons 222 relating to right justification, centering, and left justification of text. Further provided in image 200, is field 224, which lists additional Excel (trademarked) features, currently hidden.

The grid or spreadsheet 226 includes a plurality of rows, such as rows “1” through “27”, and a plurality of columns, such as columns “A” through “L”. The grid 226 is comprised of a plurality of entry fields, rectangular matrix elements, or cells. For example row “1” has entry fields, matrix elements, or cells “A1”, “B1”, “C1”, “D1”, “E1”, “F1”, “G1”, “H1”, “I1”, “J1”, “K1”, and “L1”. The rectangular matrix elements or cells may be identified with the row first and the column second or the column first and the row second (i.e. “1A” or “A1”).

In accordance with an embodiment of the present invention, a plurality of mathematical equations is represented on the grid 226. The equation “3×5=15” is shown as follows: the number “3” has been entered into the matrix element “C1”, the number “5” has been entered into the matrix element “C2”, the number “15” has been calculated and entered into the matrix element “C3”, and the mathematical operand “×” (for multiplication) has been entered into the matrix element “B2”. In addition, a double line is provided where matrix element “C2” and matrix element “C3”meet. Values are copied into the spreadsheet 226 when the calculator's operands or operator keys, of buttons 110, are pressed. The double lines & total are listed on the spreadsheet when the “=” operand or operator key of buttons 110 shown in FIG. 2, is pressed.

Similarly, the equations “7+5+3=15”, “−10−(−20)−(−5)=15, “40−5=35 ”, “16/2=8”, “500+400−200=700”, “52.00+67.25+85.95=205.20”, “1000×5=5000”, “0.85×100=85”, “(600−300)/2=150”, “48×7=336”, “600−300−200+1=101”, and “69−58=4002” are represented on the grid 226. The image 200 includes up scroll arrow 226a, down scroll arrow 226b, left scroll arrow 226c, and right scroll arrow 226d, to scroll to different areas of the grid 226.

One or more embodiments of the present invention provide a computer based calculator that produces output in a printable form. An operator of a computer based calculator can keep track of what values he or she has entered into the computer based calculator. One or more embodiments of the present invention also track what calculations the operator has performed. The functionality of the calculator may work much like an adding machine, with a printout. In the examples shown, embodiments of the present invention use Microsoft Visual Basic 6 (trademarked) as the programming language, and Microsoft Excel (trademarked) as the output medium.

One of the advantages of using one or more embodiments of the present invention is that businesses with a personal computer will no longer need to also purchase an adding machine, or a calculator with a print-out feature, to keep track of their accounting or inventory work. People who are not familiar with spreadsheets, but who are familiar with running a calculator, can take advantage of the versatility in spreadsheet formatting for their printouts.

Organization is improved over an adding machine's long printed tapes, as multiple columns of calculations can be printed to one sheet.

In operation, a user performs calculations on the screen based calculator, such as calculator or image 100 shown in FIG. 2, similar to a hand held calculator, but typically using a computer keyboard or computer mouse of interactive device 14 to enter numbers or select keys or buttons of keypads 108 or 110. If the “Load Excel” button 112 is pressed, an instance of the computer program Excel (trademarked) will open on the computer screen of monitor 12, such as image 200 as shown in FIG. 3, and a running total, or list of the user's calculations, will be captured on an Excel (trademarked) worksheet or grid 226, for example, as shown in FIG. 3.

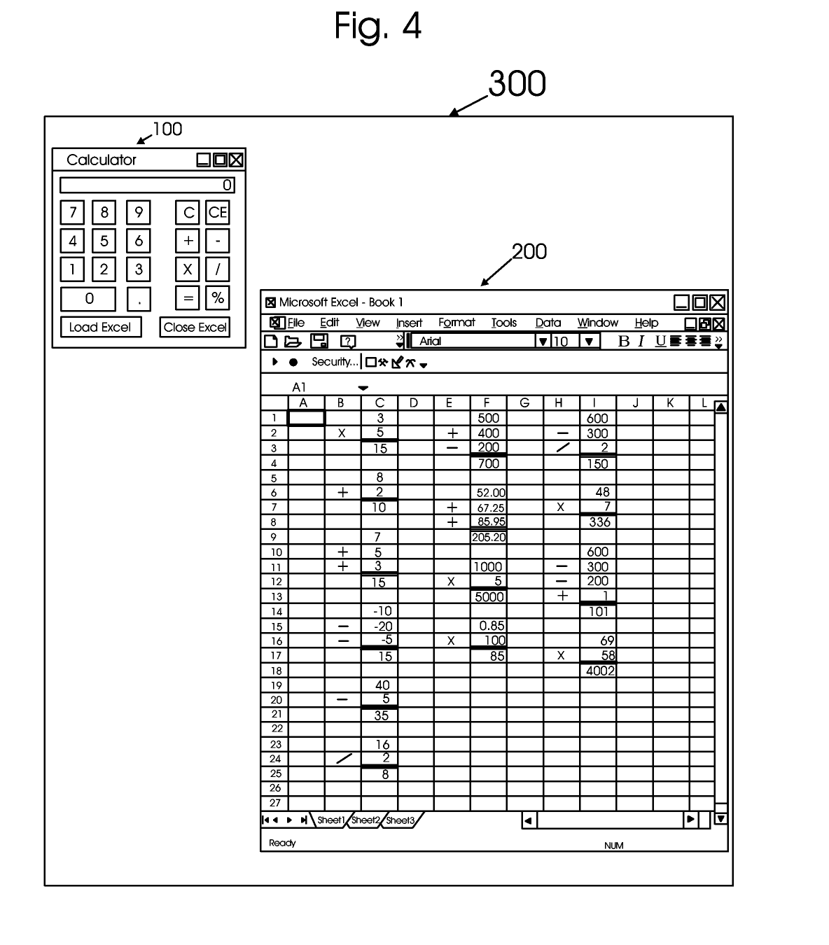

The processor 10 may include, and may run and operate a stand alone computer program for the display of image or calculator 100 and for the processing of data entered into the image or calculator 100 or displayed as part of the image or calculator 100. When an individual activates (such as by clicking on with a computer mouse of interactive device 14) the “Load Excel” button 112, the processor 10 may cause the spreadsheet image 200 to be displayed on the screen of the monitor 12 along with the calculator image 100 as part of an overall image 300 as shown in FIG. 4. In addition, after the “Load Excel” button 112 is activated, the spreadsheet or grid 226 begins to track the work done in the calculator image 100.

In the embodiment shown in FIGS. 3 and 4, numbers for calculations are listed in the spreadsheet or grid 226 from cell C1 down to cell C27, then move across to cell F1 when cell C27 is full. As shown in FIG. 3, the processor 10 will provide an empty cell between equations. For example, cell “C4” is empty between the equation “3×5=15” and “8+2=10” in column C. The appropriate mathematical operator, such as one of “+”, “−”, “/”, and “×” are placed in the column to the left of the numbers. For example, cell B2 includes “×” and cell B6 includes “+”.

When cells F1 down to F27 of spreadsheet 226 are full, then column 1 will then get filled. When cells I1 to I27 are filled, a second printable page will start at cell A29, and so on. These settings may be provided as a default by the computer program running on the processor 10, such as the computer program at the end of this section. The computer program may allow a user to change the printable page from either the calculator or image 100, or the print range features available in Excel (trademarked). When the “Close Excel” button 114 shown in FIG. 2 is activated, such as by clicking on, the user will be asked, such as by a prompt or image, if they'd like to save the spreadsheet 226 as an Excel (trademarked) file. If not, Excel (trademarked) will close, and only the calculator or image 100 will be shown on the screen of the monitor 12.

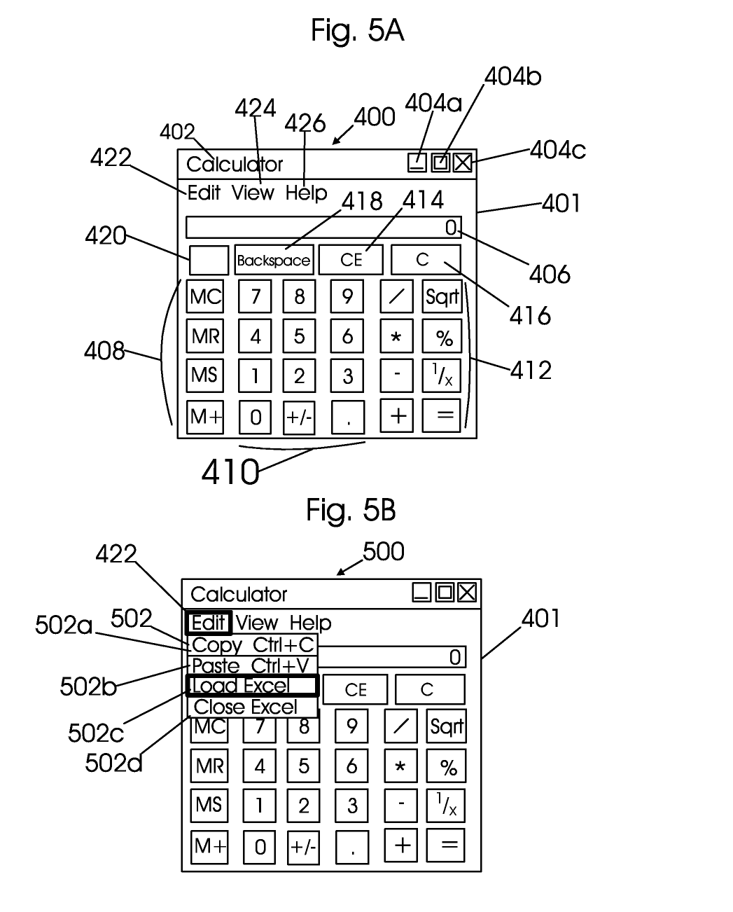

Alternatively, the “Load Excel” button 112 and the “Close Excel” button 114 functions could be implemented as items on a calculator's menu (similar to Copy or Paste functions) as shown by FIGS. 5A and 5B. FIGS. 5A and 5B show images 400 and 500 in accordance with another embodiment of the present invention.

In FIG. 5A, the image 400 includes a calculator default image 401, a calculator title or designation 402, minimize, maximize, and close icons 404a, 404b, and 404c, display field 406, keypads (or sets of buttons or fields) 408, 410, and 412, buttons 414, 416, 418, and 420, “Edit” field 422, “View” field 424, and “Help” field 426. The image 400 may be a typical computer calculator image, which is provided and can be displayed in a known “Windows” (trademarked) operating system. For a typical “Windows” calculator clicking on the “Edit” field 422 will produce a drop down menu. However, in accordance with an embodiment of the present invention, fields are added for “Load Excel” and “Close Excel” as shown in FIG. 5B. FIG. 5B shows a drop down menu 502 including fields 502a, 502b, 502c, and 502d. Fields 502a and 502b are for “Copy” and “Paste” as known in the art. In accordance with an embodiment of the present invention, fields 502c and 502d are added for “Load Excel” and “Close Excel” and when clicked on function similar to “Load Excel” button 112 and “Close Excel” button 114, respectively, as shown in FIG. 2. The dark outline surrounding the “Edit” field 422 shows that it has been selected in FIG. 5B and the dark outline surrounding the “Load Excel” field 502c shows that it has been selected also, which would cause the spreadsheet 226 to appear next to the calculator 401, similar to FIG. 4. In FIG. 5B the drop down or pull down menu 502 partially obscures the default calculator image 401.

As space is taken up on the printable area of a spreadsheet or grid 226 shown in FIG. 3, new columns may be added until a full eight and one-half by eleven sheet of paper is used. A new printable sheet would then be started below the first. If the number of rows usable in an Excel (trademarked) worksheet (65,536 rows) is exceeded, printing would begin on a new worksheet.

Instead of the “Excel” (trademarked) computer program, the calculations can be recorded to a different computer program, such as a different spreadsheet program. In that case, the buttons or fields 112 and 114 shown in FIG. 2, or the buttons or fields 502c and 502d shown in FIG. 5B, would typically have different designations or indicia, such as load spreadsheet and close spreadsheet, or load program and close program, respectively.

The following is a possible computer program, written in Microsoft (trademarked) Visual Basic 6 (trademarked) which can be run on the processor 10 shown in FIG. 1, to implement an embodiment of the present invention.

Computer Code:

Public objExcel As Excel.Application

Public wb As Excel.Workbook

Public ws As Excel.Worksheet

Public pSngRowCounter As Single

Public pSngColumnCounter As Single

Public binPrintFinal As Boolean

Public binListofCalcs As Boolean

Public pBinEqualsPressed As Boolean

Written By P. Powles

Public Sub load Excel( )
Set objExcel=CreateObject(“Excel.Application”)
Set wb=objExcel.Workbooks.Add
‘Set ws=wb.Worksheets.Add
objExcel.Visible=True

End Sub
Readout=Readout/100
Lastinput=“Ops”
OpFlag=“%”
NumOps=NumOps+1
DecimalFlag=True

End Sub

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

What is claimed is:

1. An apparatus comprising:
a computer processor;
an interactive device;
a computer memory; and
a computer monitor having a screen
wherein the computer processor is programmed to display on the screen of the computer monitor a calculator image having a first field which can be activated using the interactive device to cause calculations performed using the calculator image to be displayed on the screen of the computer monitor on a spreadsheet image.

2. The apparatus of claim 1 wherein
the calculator image has a second field, which can be activated using the interactive device to stop calculations performed using the calculator image from being displayed on the spreadsheet image.

3. The apparatus of claim 2 wherein
the second field when activated allows the user to save calculations performed using the calculator image to the computer memory.

4. The apparatus of claim 1 wherein
the processor causes the calculator image and the spreadsheet image to be displayed on the screen of the computer monitor at the same time when the first field is activated.

5. The apparatus of claim 1 wherein
the spreadsheet image is produced by an Excel (trademarked) computer program.

6. The apparatus of claim 1 wherein
the calculator image is produced by a Windows (trademarked) computer program.

7. The apparatus of claim 1 wherein
the calculations include a plurality of equations, and the computer processor is programmed to display the plurality of equations on the screen of the computer monitor at the same time.

8. The apparatus of claim 7 wherein
the plurality of equations are displayed spaced apart from one another on the screen of the computer monitor.

9. A method comprising
displaying on a screen of a computer monitor a calculator image having a first field which can be activated using an interactive device to cause calculations performed using the calculator image to be displayed on the screen of the computer monitor on a spreadsheet image.

10. The method of claim 9 wherein
the calculator image has a second field which can be activated using the interactive device to stop calculations performed using the calculator image from being displayed on the spreadsheet image.

11. The method of claim 10 wherein
the second field when activated allows a user to save calculations performed using the calculator image to a computer memory.

12. The method of claim 9 further comprising
causing the calculator image and the spreadsheet image to be displayed on the screen of the compute monitor at the same time when the first field is activated.

13. The method of claim 9 wherein
the spreadsheet image is produced by an Excel (trademarked) computer program.

14. The method of claim 9 wherein
the calculator image is produced by a Windows (trademarked) computer program.

15. The method of claim 9 wherein
the calculations include a plurality of equations, and
further comprising displaying the plurality of equations on the screen of the computer monitor at the same time.

16. The apparatus of claim 15 wherein
the plurality of equations are displayed spaced apart from one another on the screen of the computer monitor.
